(19) United States
(12) Patent Application Publication
(10) Pub. No.: US 2025/0128339 A1
(43) Pub. Date: Apr. 24, 2025

(54) Hole Saw with Adjustable Cutting Dimension

(71) Applicant: Milwaukee Electric Tool Corporation, Brookfield, WI (US)

(72) Inventor: Julian L. Kinneavy, Wauwatosa, WI (US)

(21) Appl. No.: 18/827,116

(22) Filed: Sep. 6, 2024

Related U.S. Application Data
(60) Provisional application No. 63/592,669, filed on Oct. 24, 2023.

(51) Int. Cl. B23B 51/04

(52) U.S. Cl. CPC B23B 51/0426

(57) ABSTRACT

A hole saw including an arbor, a body, and a plurality of blade assemblies slidably mounted on the body is provided. The hole saw has an adjustable size such that a user may change spacing of the blade assemblies to adjust the dimensions (e.g., the diameter) of the hole cut by the hole saw. In a certain embodiment, the body includes a plurality of pairs of wings and each blade assembly is slidably mounted on one of the plurality of pairs of wings. When a first blade assembly of the plurality of blade assemblies is moved along its respective pair of wings, a first wing in each of the pairs of wings rotates, and the other blade assemblies are moved along their respective pairs of wings.

### CROSS-REFERENCE TO RELATED PATENT APPLICATION

The present application claims the benefit of and priority to U.S. Provisional Application No. 63/592,669 filed on Oct. 24, 2023, which is incorporated herein by reference in its entirety.

### BACKGROUND OF THE INVENTION

The present invention relates generally to the field of tools. The present invention relates specifically to a hole saw having an adjustable size such that a user may change the blade spacing to adjust the dimensions (e.g., the diameter) of the hole cut by the hole saw.

### SUMMARY OF THE INVENTION

One embodiment of the invention relates to a hole saw including a central axis, a body centered on the central axis, an arbor centered on the central axis and coupled to the body, and a plurality of blade assemblies. The body includes a plurality of pairs of wings positioned radially around the central axis and extending away from the central axis. Each pair of wings includes a first wing with an arcuate slot extending radially away from the central axis and a second wing positioned below the first wing in a direction along the central axis. The arbor includes a shaft configured to engage a driving tool and a drill bit coupled to the arbor opposite the shaft along the central axis. The drill but is configured to engage a workpiece. The plurality of blade assemblies is configured to cut a workpiece. Each blade assembly is slidably mounted on one of the plurality of pairs of wings and at least a portion of each blade assembly is positioned with a respective arcuate slot of a respective first wing. When a first blade assembly of the plurality of blade assemblies is moved along its respective pair of wings, each first wing in the plurality of pairs of wings rotates with respect to the central axis, and the other blade assemblies in the plurality of blade assemblies are moved along their respective pairs of wings.

Another embodiment of the invention relates to a tool for cutting a hole in a workpiece. The tool includes a central axis, a body centered on the central axis, an arbor centered on the central axis and coupled to the body, and a blade assembly. The body includes a first plate, a first slot formed in the first plate and extending radially away from the central axis, a second plate, and a second slot formed in the second plate and extending radially away from the central axis. The second slot is aligned with the first slot such that at least a portion of the second slot overlaps with the first slot. The arbor includes a shaft configured to engage a driving tool. The blade assembly is slidably mounted in the first slot and slidably mounted in the second slot. The blade assembly includes a blade configured to cut a workpiece. When the blade assembly is moved along the first slot in a first direction away from the central axis, the blade assembly moves along the second slot in the first direction.

Another embodiment of the invention relates to a hole cutting tool including a central axis, an arbor, a first plate, a second plate, and a blade assembly. The arbor is centered on the central axis and includes a shaft configured to engage a driving tool. The shaft extends away from the arbor in a first direction along the central axis. The first plate is centered on the central axis and mounted on the arbor. The first plate is configured to rotate with respect to the central axis. The first plate includes a first wing extending away from the central axis and a slot formed along at least a portion of the first wing and extending radially away from the central axis. The second plate is centered on the central axis and mounted on the arbor. The second plate includes a second wing extending linearly away from the central axis and at least a portion of the second wing overlaps with the slot of the first wing. The blade assembly is slidably coupled to the first wing and slidably coupled to the second wing. The blade assembly include a blade extending away from the blade assembly in a second direction along the central axis opposite the first direction.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a top perspective view of a hole saw according to an exemplary embodiment;

FIG. 2 is a bottom perspective view of the hole saw of FIG. 1, according to an exemplary embodiment;

FIG. 3 is a side plan view of the hole saw of FIG. 1, according to an exemplary embodiment;

FIG. 4 is a top plan view of the hole saw of FIG. 1, according to an exemplary embodiment;

FIG. 5 is an exploded view of the body of the hole saw of FIG. 1, according to an exemplary embodiment;

FIG. 6 is a detailed view of the arbor and drill bit of the hole saw of FIG. 1, according to an exemplary embodiment;

FIG. 7 is an exploded view of the arbor and drill bit of FIG. 6, according to an exemplary embodiment;

FIG. 8 is a detailed view of a blade assembly of FIG. 1, according to an exemplary embodiment;

FIG. 9 is an exploded view of the blade assembly of FIG. 8, according to an exemplary embodiment;

FIG. 10 is a top perspective view of a hole saw without a blade assembly, according to another exemplary embodiment;

FIG. 11 is a bottom perspective of the hole saw of FIG. 10, according to an exemplary embodiment;

FIG. 12 is an exploded view of a body of the hole saw of FIG. 10, according to an exemplary embodiment;

FIG. 13 is a detailed view of the bearing assembly of the hole saw of FIG. 10, according to an exemplary embodiment; and

FIG. 14 is an exploded view of the bearing assembly of FIG. 13, according to an exemplary embodiment.

### DETAILED DESCRIPTION

Referring generally to the figures, various embodiments of a hole saw configured to provide adjustable blade positioning to allow a user to change the dimensions of the hole cut by the saw are shown and described.

Various hole saws discussed herein have an upper plate with first slots, shown as arcuate slots, and a lower plate with second slots, shown as linear slots. Blade assemblies are mounted in pairs slots, each pair having one arcuate slot and one linear slot. When a blade assembly is moved along a linear slot, the upper plate rotates, and the arcuate slots simultaneously move the other blade assemblies along their respective linear slots. Applicant believes that this structure allows for more efficient size adjustment (i.e., change in diameter) of the hole saw as compared to typical adjustable hole saws where the position of each blade relative to the arbor or central drill bit must be adjusted individually. Additionally, in various embodiments, the hole saw includes three pairs of wings, each pair including a blade assembly mounted in an arcuate slot and a linear slot. Compared to a typical hole saw with two individually adjustable blades, Applicant believes that the three pairs of wings allow for greater balance, and more clearly define the cutting plane, providing an easier first cut or score.

In other various embodiments, the hole saw includes a body with pairs of first wings and second wings. Each first wing includes an arcuate slot and bearing assemblies are mounted in the arcuate slots and surrounding the second wings. Applicant believes that this structure provides reduced friction when a blade mounted on the bearing assembly is moved along the pairs of wings.

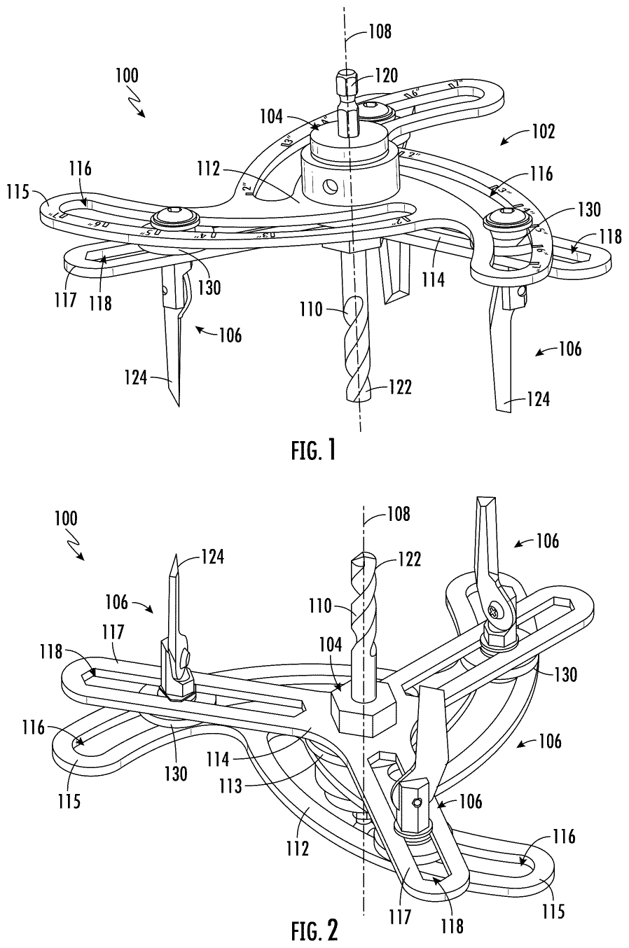

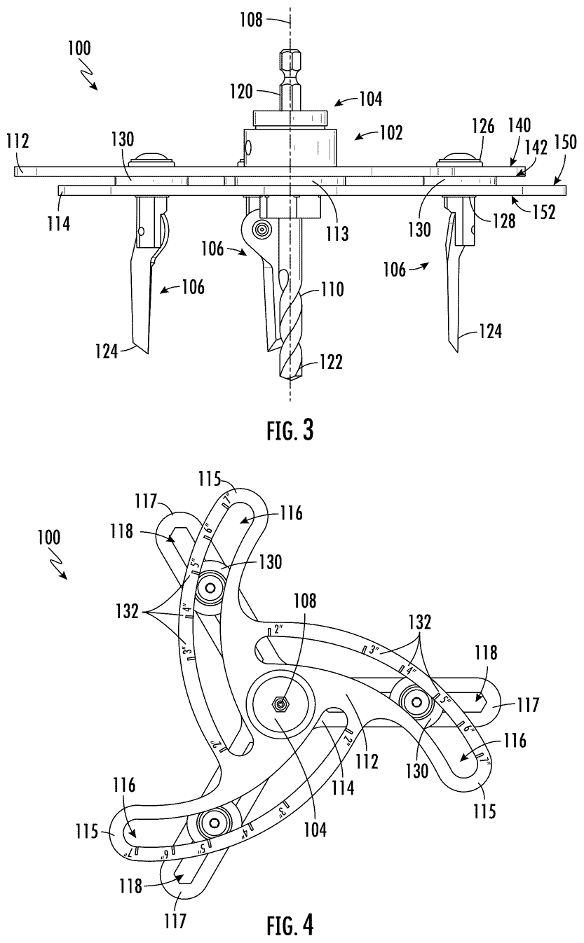

Referring to FIGS. 1-4, a hole saw 100 is shown and described. Hole saw 100 is configured to be selectively coupled to a driving tool, such as an impact driver or a rotatory drill, in order to cut holes in a workpiece, such as drywall, wood, plastic, or other material. Specifically, hole saw 100 includes at least three position adjustable blades that allows the user to select the size of the hole (e.g., the diameter of the hole) cut by hole saw 100.

Hole saw 100 includes a body 102, an arbor 104, and a plurality of blade assemblies 106. Arbor 104 is coupled to body 102 and is configured to receive a driving tool. Blade assemblies are slidably mounted on body 102. Hole saw 100 further includes central axis 108 and drill bit 110. Drill bit 110 is coupled to arbor 104 and is configured to engage with a workpiece. As shown, body 102, arbor 104, and drill bit 110 are centered on and extend along central axis 108.

Body 102 includes a first plate or upper plate 112, a second plate or lower plate 114, and a central bearing, such as thrust bearing 113. Lower plate 114 is located below upper plate 112 along central axis 108. Thrust bearing 113 is positioned between upper plate 112 and lower plate 114. Thrust bearing 113 assists in the rotation of upper plate 112 and lower plate 114 with respect to each other when a user adjusts the dimensions of hole saw 100.

Upper plate 112 includes a plurality of first slots, shown as arcuate slots 116, which extends through upper plate 112. Arcuate slots 116 extend radially away from central axis 108 and define an arc or curve with respect to central axis 108. Lower plate 114 includes a plurality of second slots, shown as linear slots 118, which extends through lower plate 114 in the substantially the same direction as the arcuate slots 116. Linear slots 118 extend radially away from central axis 108 and extend substantially linearly in a direction away from central axis 108. As shown, both arcuate slots 116 and linear slots 118 have a depth dimension extending through their respective plates measured parallel to central axis 108. Each linear slot 118 corresponds to one of the plurality of arcuate slots 116. At least a portion of each linear slot 118 overlaps with a corresponding arcuate slots 116. In this way, when blade assemblies 106 are mounted on body 102, blade assemblies 106 are each slidably mounted in pairs of slots: one linear slot 118 and one arcuate slot 116.

Arbor 104 is coupled to body 102 and includes a shaft 120. Shaft 120 is configured to selectively couple to a driving tool. When a driving tool is attached to shaft 120, it can rotate hole saw 100 around central axis 108. Drill bit 110 is coupled to arbor 104 opposite from shaft 120 along central axis 108. Drill bit 110 has a tip 122 configured to engage with a workpiece and drill a hole when a driving tool rotates hole saw 100.

Plurality of blade assemblies 106 extends through body 102. Each blade assembly 106 is configured to cut into a workpiece. Additionally, each blade assembly 106 is adjustable along body 102 to allow a user to change the dimensions (e.g., diameter) of a hole cut by hole saw 100. Blade assemblies 106 include a blade 124, an upper edge 126, and a lower edge 128. Blades 124 are coupled to lower edge 128 and extend in a direction parallel to drill bit 110. As such, blades 124 may engage a work piece at the same time as drill bit 110. Blades 124 are spaced from central axis 108 and drill bit 110 such that central axis 108 defines the center of a hole cut by hole saw 100.

Each upper edge 126 of the plurality of blade assemblies 106 is received and retained within one of the arcuate slots 116, and each lower edge 128 is received and retained within one of the linear slots 118. In this way, each blade assembly 106 can slide along an arcuate slot 116 and a linear slot 118 at the same time. Each blade assembly 106 also includes a thrust bearing 130 located between upper plate 112 of body 102 and lower plate 114 of body 102. Thrust bearing 130 assists in the rotation of upper plate 112 and lower plate 114 with respect to each other, as well as the movement of blade assemblies 106 along body 102, and specifically along pairs of slots 116, 118.

In order to change the size of the hole cut by hole saw 100, a user slides blade assemblies 106 along body 102 in a direction towards, or away from, central axis 108. Specifically, blade assemblies 106 are moved along the pairs of arcuate slots 116 and linear slots 118. When a user slides a blade assembly 106 along its pair of slots 116, 118, the other blade assemblies 106 are moved along their respective slots 116, 118.

As shown, hole saw 100 includes three blade assemblies 106, three arcuate slots 116 in upper plate 112, and three linear slots 118 in lower plate 114. Lower plate 114 of body 102 is fixed in place. That is, lower plate 114 is coupled to arbor 104 such that it does not rotate independently from arbor 104. Upper plate 112 is rotatably coupled to arbor 104 and may rotate with or independently from lower plate 114 and arbor 104.

When a first blade assembly 106, is moved along the linear slot 118 that it is mounted in, upper plate 112 rotates with respect to lower plate 114 and around central axis 108. The other blade assemblies 106 are simultaneously moved along their linear slots 118 by the change in position of their respective arcuate slots 116. The curved edges of arcuate slots 116 push the blade assemblies 106 in the same direction as the first blade assembly 106, towards, or away from, central axis 108. In other embodiments, upper plate 112 is fixed in place and lower plate 114 rotates with respect to upper plate 112 in order to move blade assemblies along the pairs of slots 116, 118.

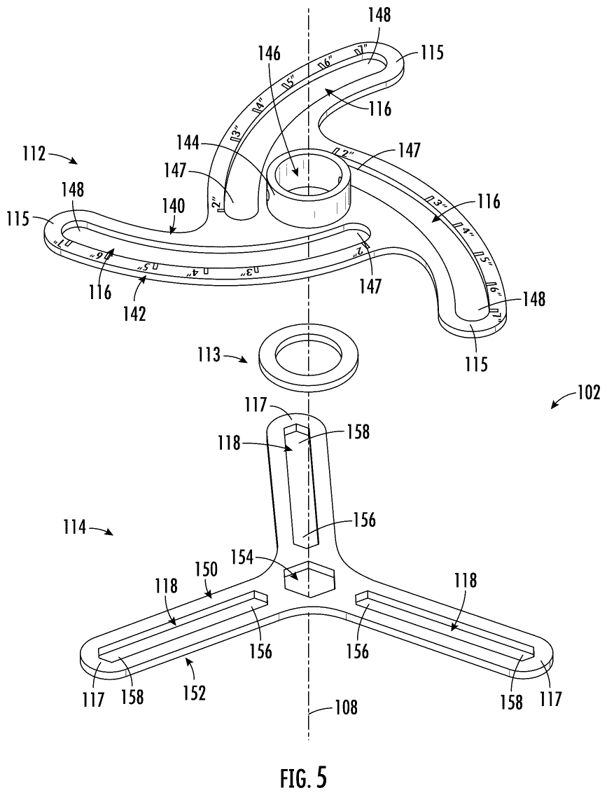

Referring to FIG. 4, upper plate 112 includes a plurality of indicia 132, individually indicum 132. Indicia 132 are adjacent to each arcuate slot 116 and extend along the entire length of each arcuate slot 116. Indica 132 extend radially from central axis 108 and are spaced along arcuate slot 116 at varying distances. Indicia 132 are represented by a series of numbers identifying the size of the hole that will be cut by hole saw 100. In the embodiment shown, the indicia 132 indicate the diameter of the hole in inches and range between 2 inches and 7 inches. In other embodiments, the indicia 132 may represent the diameter in metric units (e.g., centimeters).

A user can use indicia 132 to select a size of a hole they would like to cut with hole saw 100. The user can then move a blade assembly 106 to the desired indicium 132, or diameter size, and secure the blade assembly 106 in place. As described above, the other blade assemblies 106 will be simultaneously moved to a location adjacent to the corresponding indicum 132, or diameter size, of the other arcuate slots 116. The user can then adjust and secure the other blade assemblies 106 in place. The user can then use hole saw 100 to make a hole in a workpiece based on the adjusted size.

Referring to FIG. 5, an exploded view of body 102 of hole saw 100 is shown. Upper plate 112 has a top surface 140 and a bottom surface 142. Upper plate 112 includes a central projection 144 that extends in a direction away from top surface 140. A through hole 146 extends through central projection 144 and upper plate 112. Through hole 146 is configured to receive an upper section 160 of arbor 104 such that upper plate 112 is mounted on upper section 160 of arbor 104. As shown, central projection 144 is cylindrical shaped with its center aligned on central axis 108. So, central projection 144 is centered on body 102.

Upper plate 112 further includes a plurality of first wings 115. Each arcuate slot 116 extends along at least a portion of a first wing 115. As shown, first wing 115 are curved such that they extend radially away from central axis 108. First wings 115 are evenly spaced from each other around central axis. Arcuate slots 116 are spaced a distance from central axis 108 and have a length that extends radially away from central axis 108. Arcuate slots 116 and first wings 115 define a curve with respect to central axis 108. Arcuate slots 116 and first wings 115 curve in relatively the same direction. As shown, arcuate slots 116 and first wings 115 curve in a clockwise direction with respect to central axis 108. Each arcuate slot 116 has a first end 147 and a second end 148. Each first end 147 is adjacent to central projection 144, while each second end 148 is located at the end of first wing 115 located furthest from central axis 108.

Lower plate 114 has a top surface 150 and a bottom surface 152. Lower plate 114 includes a through hole 154 configured to receive a lower section 162 of arbor 104. Lower plate 114 is mounted on lower section 162 of arbor 104. As shown, through hole 154 is a hexagonal-shape and is centered on central axis 108.

Lower plate 114 further includes a plurality of second wings 117. Each second wing 117 corresponds to a respective first wing 115 defining pairs of first and second wings. Each second wing 117 has a length that extends radially away from central axis 108. Second wings 117 extend in a direction linearly away from central axis 108. In a certain embodiment, second wing 117 extends in a direction substantially orthogonal to central axis 108. Second wings 117 are evenly spaced from each other around central axis 108. Each linear slot 118 extends along at least a portion of a second wing 117. Linear slots 118 have a length that extends radially away from central axis 108 along second wing 117. In a certain embodiment, linear slots 117 also extend orthogonal to central axis 108. Linear slots 118 have a first end 156 and a second end 158 opposite from first end 156. First end 156 is positioned adjacent to through hole 154, while second end 158 is at an end of second wing 117 located furthest from central axis 108.

Central thrust bearing 113 is positioned between top surface 150 of lower plate 114 and bottom surface 142 of upper plate 112. In a certain embodiment, central thrust bearing allows for upper plate 112 to move with respect to lower plate 114 when a user adjust the dimensions of hole saw 100. When upper plate 112 rotates around central axis 108, thrust bearing 113 reduces the rotational friction transferred to the lower plate 114.

As shown, upper plate 112 includes three first wings 115 and three arcuate slots 116, and lower plate 114 includes three second wings 117 and three linear slots 118. Applicant believes that using three first wings 115 and three second wings 117 provides for greater stability of the hole saw.

When assembled, each blade assembly 106 is mounted in a first wing 115 and a corresponding second wing 117. First wing 115 and second wing 117 extend along planes that are generally parallel with each other. This allows for the arcuate slot 116 in first wing 115 to at least partially overlap with the linear slot 118 of second wing 117. Specifically, arcuate slot 116 and linear slot 118 are aligned such that when blade assemblies 106 are positioned in first ends 147 of arcuate slots 116, blade assemblies 106 also located in first ends 156 of the corresponding linear slots 118. In the same way, when blade assemblies 106 are positioned in second ends 148 of arcuate slot 116, they are also located in second ends 158 of the corresponding linear slot 118. As such, when a user slides a blade assembly 106 along its pair of slots 116, 118, the other blade assemblies 106 are moved along their respective slots 116, 118, and the positioning of the blade assemblies 106 is relatively the same with respect to the indicia 132.

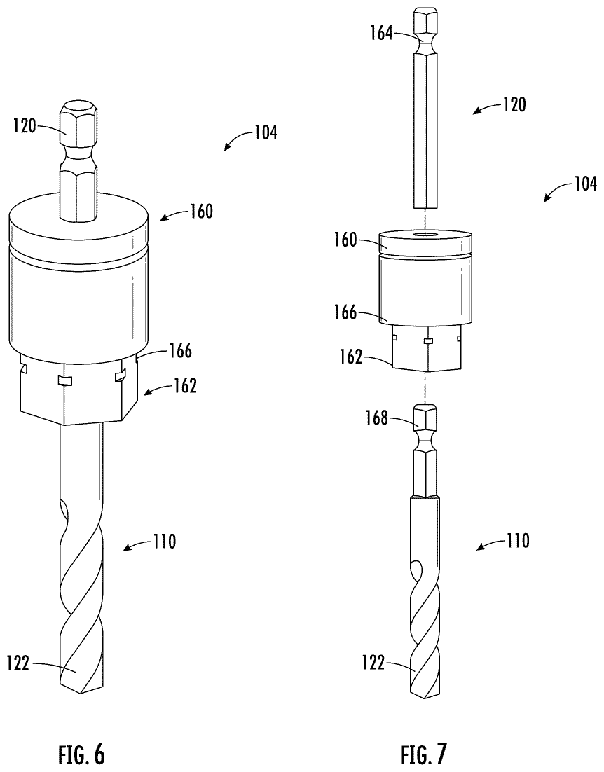

Referring to FIGS. 6-7, arbor 104 and drill bit 110 are shown according to an exemplary embodiment. Arbor 104 includes shaft 120, upper section 160, and lower section 162. Shaft 120 is coupled to and extends from upper section 160. Shaft 120 includes an engagement end 164. Engagement end 164 is configured to removably couple to a driving tool in order to rotate arbor 104. As shown, engagement end 164 is a hexagonal shape. In various embodiments, engagement end 164 is coupled to upper section 160 through an interference fit, such a press fit or friction fit.

When hole saw 100 is assembled, upper plate 112, and central projection 144, engages and surrounds at least a portion of upper section 160, and lower plate 114 engages and surrounds at least a portion of lower section 162. More specifically, arbor 104 includes a step 166 between upper section 160 and lower section 162. Lower plate 114 abuts step 166 when engaged with arbor 104. As shown, upper section 160 is a circular shape, and lower section 162 is a hexagonal shape. Through hole 146 of upper plate 112 and through hole 154 of lower plate 114 match the shape of upper section 160 and lower section 162, respectively.

Drill bit 110 is removably coupled to lower section 162. Drill bit includes an attachment end 168 located opposite from tip 122. Attachment end 168 is received and retained in lower section 162. Tip 122 extends downwards from lower section 162 and is configured to engage with a workpiece in order to drill a hole. As shown, attachment end 168 is a hexagonal shank. Arbor 104 is configured to receive and retain a variety of drill bits such that a user can remove and replace drill bits as needed.

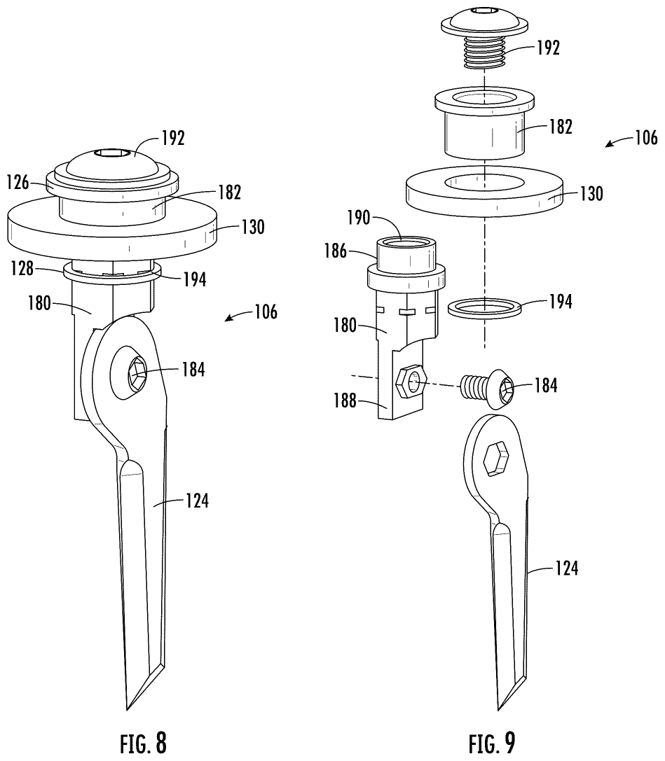

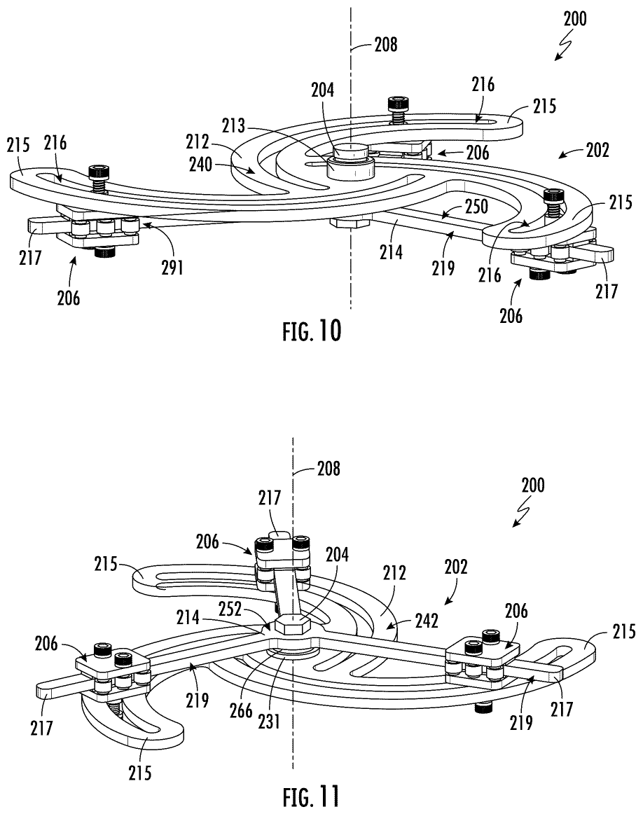

Referring to FIGS. 8-9, one of the blade assemblies 106 of hole saw 100 is shown according to an exemplary embodiment. Blade assembly 106 is configured to be removably coupled to body 102. Blade assembly 106 includes blade 124, a body, or blade holder 180, a sleeve bearing 182 coupled to blade holder 180, and thrust bearing 130 coupled to sleeve bearing 182.

Blade holder 180 includes an upper end 186 and a lower end 188 opposite from upper end 186. Blade 124 is removably coupled to lower end 188. Blade 124 extends in a direction downward from lower end 188 and away from bottom surface 152 of lower plate 114. Specifically, blade 124 is coupled to blade holder 180 by a screw 184. Blade 124 may be removed and replaced by a user as needed. In various embodiments, blade 124 may be made of abrasives, carbides, or metals, such as steel. So, a user can replace blade 124 with a blade made of a different material to suit the user's needs.

Upper end 186 of blade holder 180 is received and retained in sleeve bearing 182. Upper end 186 includes a threaded channel 190. Threaded channel 190 is configured to receive a bolt or screw 192. Screw 192 couples upper end 186 to sleeve bearing 182 and secures upper edge 126 to top surface 140 of upper plate 112.

Blade assembly 106 further includes retaining ring 194. Retaining ring 194 defines lower edge 128 of blade assembly 106. Retaining ring 194 assists in retaining blade holder 180 in position between upper plate 112 and lower plate 114. As such, upper edge 126 engages top surface 140 of upper plate 112 and retaining ring 194 engages bottom surface 152 of lower plate 114 to retain and secure blade assemblies 106 in slots 116, 118.

Thrust bearing 130 is coupled to an outer surface of sleeve bearing 182. Thrust bearing 130 is located between bottom surface 142 of upper plate 112 and top surface 150 of lower plate 114. Thrust bearing 130 and sleeve bearing 182 assist blade assembly 106 in traveling along slots 116, 118.

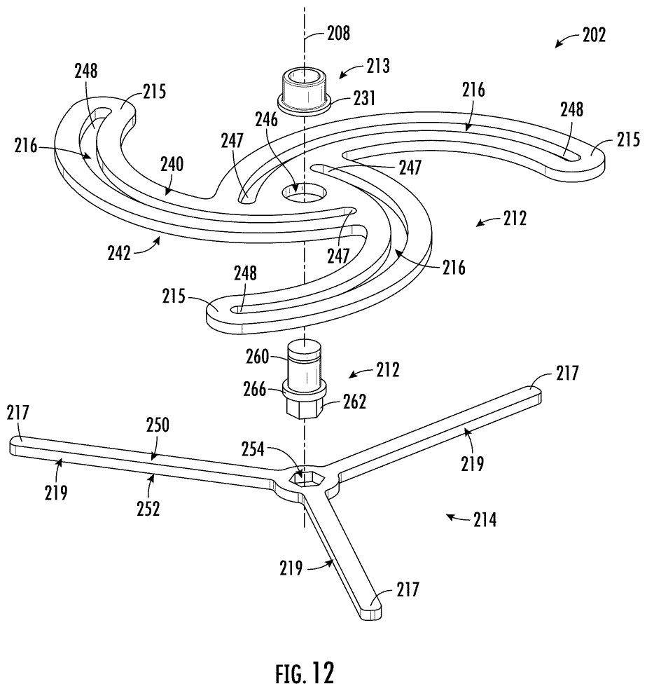

Referring to FIGS. 10-14, a hole saw 200 is shown. Hole saw 200 is substantially the same as hole saw 100 except for the differences discussed herein. In particular, hole saw 200 includes a body 202 with an upper plate 212 and a lower plate 214. A bearing assembly 206 is mounted in an arcuate slot 216 that is formed in upper plate 212. Bearing assembly 206 surrounds a second wing 217 of lower plate 214. Applicant believes that the bearing assembly 206 provides for reduced friction and easier manufacturing.

Referring to FIGS. 10-12, hole saw 200 includes body 202, an arbor 204, and a plurality of bearing assemblies 206 slidably mounted on body 202. Blades, such as blades 124, may be mounted on bearing assemblies 206 in order to cut holes in a workpiece. Hole saw 200 is adjustable, such that a user can select the size of the hole (e.g., the diameter of the hole) cut by hole saw 200 by sliding the bearing assemblies 206 radially along body 202 with respect to a central axis 208.

Body 202 is centered on central axis and includes upper plate 212, lower plate 214, and a central bearing, such as central sleeve bearing 213. Central sleeve bearing 213 assists in the rotation of upper plate 212 and lower plate 214 with respect to each other when a user adjusts the dimensions of hole saw 200.

Upper plate 212 includes a top surface 240, a bottom surface 242, and a plurality of first wings 215. Each arcuate slot 216 extends along at least a portion of a first wing 215. As shown, first wings 215 are curved such that they extend radially away from central axis 208. Arcuate slots 216 curve in relatively the same direction as first wings 215. Each arcuate slot 216 has a first end 247 and a second end 248. Each first end 247 is located closer to central axis 208 than each second end 248. That is, a distance measure between first end 247 and central axis 208 is less than a distance measured between second end 248 and central axis 208.

Lower plate 214 includes a top surface 250, a bottom surface 252, and a plurality of second wings 217. Second wings 217 extend in a direction substantially orthogonal to central axis 208. Each second wing 217 corresponds to a one of the plurality of first wing 215. As such, body 202 defines pairs of wings: one first wing 215 and one second wing 217. Each first wing 215 and each second wing 217 extend along planes that are generally parallel with each other. This allows for at least a portion of section wing 217 to overlap with arcuate slot 216 in first wing 215.

When hole saw 200 is assembled, central sleeve bearing 213 is positioned within opening 246 formed in upper plate 212. Central sleeve bearing 213 assists upper plate 212 in moving with respect to lower plate 214 when a user adjusts the dimension of hole saw 200. Central sleeve bearing 213 includes an edge 231 positioned between bottom surface 242 of upper plate 212 and top surface 250 of lower plate 214. Edge 231 assists in retaining central sleeve bearing 213 within opening 246.

Arbor 204 includes an upper section 260 and a lower section 262. A lip 266 extends radially away from arbor 204 at the intersection between upper section 260 and lower section 262. When assembled, upper section 260 is positioned within central sleeve bearing 213 and lower section 262 is positioned within opening 254 of lower plate 214. Lip 266 is positioned between top surface 250 of lower plate 214 and bottom surface 242 of upper plate 212. Lip 266 assists in retaining arbor 204 in position between upper plate 212 and lower plate 214. When assembled, lip 266 may abut edge 231 of central sleeve bearing 213.

In various embodiments, a shaft, such as shaft 120, may be coupled to and extend from upper section 260 in order to engage a driving tool. In other various embodiments, a drill bit, such as drill bit 110, is coupled to lower section 262 of arbor 204 to engage a work piece and drill a hole.

Bearing assemblies 206 are slidably mounted along body 202 and, more specifically, along pairs of wings 215, 217. Each bearing assembly 206 surrounds second wing 217 such that bearing assembly 206 engages with an outer side surface 219 of second wing 217. A portion of each bearing assembly 206 is positioned within arcuate slot 216.

When a first bearing assembly 206, is moved along the length of second wing 217 in a direction orthogonal to central axis, upper plate 212 rotates with respect to lower plate 214 and around central axis 208, which moves first bearing assembly 206 along its arcuate slot 216. The other bearing assemblies 206 are simultaneously moved along their second wings 217 by the change in position of their respective arcuate slots 216. The curved edges of arcuate slots 216 push the bearing assemblies 206 in the same direction as the first bearing assembly 206, towards, or away from, central axis 108. In other embodiments, upper plate 212 is fixed in place and lower plate 214 rotates with respect to upper plate 212.

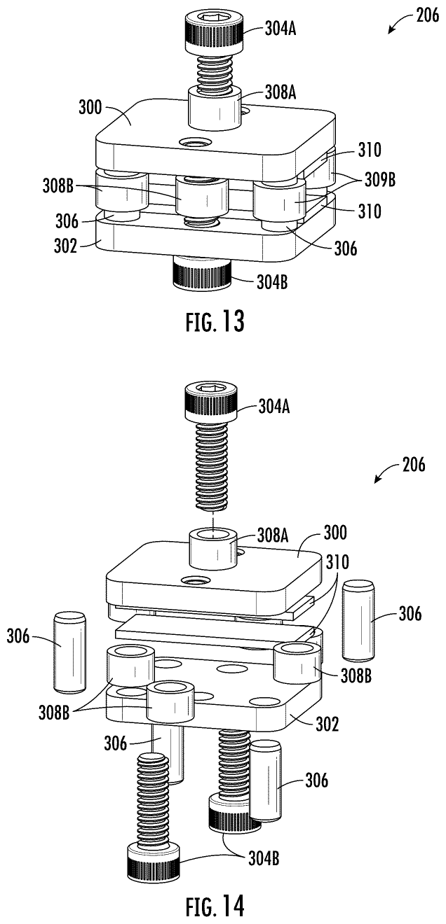

Referring to FIGS. 13-14, one of the bearing assemblies 206 of hole saw 200 is shown. Bearing assembly 206 is configured to be slidably coupled to body 202 through the use of a plurality of bearings (e.g., linear bearings, sleeve bearings, etc.) engaging with second wing 217. Bearing assembly 206 includes a top plate 300, a bottom plate 302, a plurality of fasteners, shown as screws 304, a plurality of pins 306, and a plurality of bearings, shown as sleeve bearings 308.

A first sleeve bearing 308A is positioned within arcuate slot 216 and surrounds a first screw 304A, which is retained in top plate 300 of bearing assembly 206. First sleeve bearing 308A assists bearing assembly 206 in traveling along arcuate slot 216. At least a portion of first screw 304A is positioned within arcuate slot 216. As shown, a top of screw 304A is positioned above top surface 240 of upper plate 212 when bearing assembly 206 is mounted on body 202.

A plurality of second sleeve bearings 308B are positioned between top plate 300 and bottom plate 302. When assembled, an outer surface of second sleeve bearings 308B engage outer side surface 219 of second wing 217 and assist bearing assembly 206 in traveling along second wing 217. Screws 304B are used to couple top plate 300 and bottom plate together 302, and pins 306 are positioned between top plate 300 and bottom plate 302. Second sleeve bearings 308B are mounted on screws 304B and pins 306. As shown, bearing assembly 206 includes six second sleeve bearings 308B. Two second sleeve bearings 308B surround two screws 304B, and four second sleeve bearings 308B are mounted on four pins 306.

As shown, bearing assembly 206 includes strips 310 which are used to further reduce friction between bearing assembly 206 and second wing 217. A first strip 310 is positioned between top plate 300 and top surface 250, and a second strip 310 is positions between bottom plate 302 and bottom surface 252. In a certain embodiment, strips 310 are made from ultra high molecular weight polyethylene (UHMW).

Blades, such as blades 124, may be removably mounted to bearing assemblies 206. In various embodiments, blades are coupled to bottom plate 302 and extend in a direction away from bottom plate 302 and away from top plate 300. In various embodiments, blades are coupled to bottom plate 302 through a fastener, such as a screw or bolt, such that blades are removable and/or replaceable.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A hole saw, comprising:
a central axis;
a body centered on the central axis, the body comprising a plurality of pairs of wings positioned radially around the central axis and extending away from the central axis, each pair of wings comprising:
a first wing comprising an arcuate slot extending radially away from the central axis; and
a second wing positioned below the first wing in a direction along the central axis;
an arbor centered on the central axis and coupled to the body, the arbor comprising:
a shaft configured to engage a driving tool; and
a drill bit coupled to the arbor opposite the shaft along the central axis and configured to engage a workpiece; and
a plurality of blade assemblies configured to cut a workpiece, each blade assembly slidably mounted on one of the plurality of pairs of wings and at least a portion of each blade assembly positioned within a respective arcuate slot of a respective first wing;
wherein when a first blade assembly of the plurality of blade assemblies is moved along its respective pair of wings, each first wing in the plurality of pairs of wings rotates with respect to the central axis, and the other of the plurality of blade assemblies in the plurality of blade assemblies are moved along their respective pairs of wings.

2. The hole saw of claim 1, wherein the body comprises three pairs of wings.

3. The hole saw of claim 1, wherein each second wing in the plurality of pairs of wings extends in a direction orthogonal to the central axis.

4. The hole saw of claim 1, wherein each blade assembly further comprises a bearing positioned between the respective first wing and a respective second wing, the bearing configured to assist the blade assembly in traveling along its respective pair of wings.

5. The hole saw of claim 1, wherein each blade assembly further comprises a plurality of bearings engaged with an outer side surface of a respective second wing, the plurality of bearings configured to assist the blade assembly in traveling along its respective pair of wings.

6. The hole saw of claim 1, wherein each second wing in the plurality of pairs of wings further comprises a linear slot, wherein each linear slot overlaps with at least a portion of the arcuate slot of the respective first wing.

7. The hole saw of claim 6, wherein each linear slot extends in a direction orthogonal to the central axis.

8. A tool for cutting a hole in a workpiece, the tool comprising:
a central axis;
a body centered on the central axis, the body comprising:
a first plate;
a first slot formed in the first plate and extending radially away from the central axis;
a second plate;
a second slot formed in the second plate and extending radially away from the central axis, the second slot aligned with the first slot such that at least a portion of the second slot overlaps with the first slot;
an arbor centered on the central axis coupled to the body, the arbor comprising a shaft configured to engage a driving tool; and
a blade assembly slidably mounted in the first slot and slidably mounted in the second slot, the blade assembly comprising a blade configured to cut a workpiece;
wherein when the blade assembly is moved along the first slot in a first direction away from the central axis, the blade assembly moves along the second slot in the first direction.

9. The tool of claim 8, wherein the first slot is an arcuate slot and defines a curve with respect to the central axis, and wherein the second slot is a linear slot and has a length which extends linearly away from the central axis.

10. The tool of claim 8, wherein the blade assembly is a first blade assembly, and further comprising:
a third slot formed in the first plate and spaced a distance from the first slot;
a fourth slot formed in the second plate and aligned with the third slot such that at least a portion of the fourth slot overlaps with the third slot; and
a second blade assembly slidably mounted in the third slot and slidably mounted in the fourth slot.

11. The tool of claim 10, wherein the second plate is fixed with respect to the arbor such that when the first blade assembly is moved along the second slot, the first plate rotates with respect to the central axis, and the third slot moves the second blade assembly along the fourth slot.

12. The tool of claim 10, wherein the first plate is fixed with respect to the arbor such that when the first blade assembly is moved along the second slot, the second plate rotates with respect to the central axis, and the third slot moves the second blade assembly along the fourth slot.

13. The tool of claim 8, wherein the second slot extends in a direction orthogonal to the central axis.

14. The tool of claim 8, wherein the blade assembly comprises an upper edge and lower edge, wherein the upper edge is received and retained in the first slot and the lower edge is received and retained in the second slot.

15. The tool of claim 8, wherein the first slot comprises a first end and second end, wherein a first distance measured from the central axis to the first end is less than a second distance measured from the central axis to the second end, and the second slot comprises a third end and a fourth end, wherein a third distance measured from the central axis to the third end is less than a fourth distance measured from the central axis to the fourth end, and wherein when the blade assembly is located at the first end of the first slot, then the blade assembly is located at the third end of the second slot.

16. A hole cutting tool, comprising:
a central axis;
an arbor centered on the central axis, the arbor comprising a shaft configured to engage a driving tool, the shaft extending away from the arbor in a first direction along the central axis;
a first plate centered on the central axis and mounted on the arbor, the first plate configured to rotate with respect to the central axis, the first plate comprising a first wing extending away from the central axis, and a slot formed along at least a portion of the first wing and extending radially away from the central axis;
a second plate centered on the central axis and mounted on the arbor, the second plate comprising a second wing extending linearly away from the central axis, wherein at least a portion of the second wing overlaps with the slot of the first wing; and
a blade assembly slidably coupled to the first wing and slidably coupled to the second wing, the blade assembly comprising a blade extending away from the blade assembly in a second direction along the central axis opposite the first direction.

17. The hole cutting tool of claim 16, further comprising a central bearing positioned between the first plate and the second plate and centered on the central axis, wherein the central bearing is configured to assist the first plate in rotating with respect to the central axis.

18. The hole cutting tool of claim 16, wherein the arbor further comprises an upper section and lower section positioned below the upper section along the central axis, wherein the first plate is mounted on the upper section of the arbor and the second plate is mounted on the lower section of the arbor.

19. The hole cutting tool of claim 18, wherein the lower section is a hexagonal shape, and the upper section is a cylindrical shape.

20. The hole cutting tool of claim 16, wherein the blade assembly further comprises at least one bearing, wherein an outer surface of the at least one bearing engages with an outer side surface of the second wing such that the at least one bearing assists the blade assembly in sliding along the second wing.
